(19) United States
(12) Patent Application Publication
(10) Pub. No.: US 2007/0238937 A1
(43) Pub. Date: Oct. 11, 2007

(54) System and method for controlling a tilt table

(76) Inventors: Walter Hong-Shong Chang, Jhong-Li City (TW); Shih-Wei Liu, Taichung City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/642,515

(22) Filed: Dec. 21, 2006

Related U.S. Application Data
(63) Continuation-in-part of application No. 11/019,744, filed on Dec. 23, 2004, now abandoned.

(51) Int. Cl. A61G 7/018

(52) U.S. Cl. 600/301

(57) ABSTRACT

A system and method for controlling a tilt table employs a physiological sensing module to sense the physiological status of a person lying on the tilt table and to generate at least one physiological signal. Also, the above-mentioned system and method employs a tilt table control module to receive the physiological signal mentioned above and the corresponding changed threshold of the physiological signal to compare the physiological status of the person and to generate an angle adjustment value. Whereby, the tilt table control module can perform an adjustment process to adjust the tilt table to a tilt angle according to the angle adjustment value.

### CROSS REFERENCE TO RELATED APPLICATIONS

This application is a continuation in part of applicant's earlier application, Ser. No. 11/019,744, filed 23 Dec. 2004.

### BACKGROUND OF THE INVENTION

1. Field of the Invention

This invention generally relates to a system and method for controlling a tilt table, and more particularly, to a system and method that employs the feedback physiological signal to control the tilt table.

2. Description of the Prior Art

Although a well-known tilt table can driver its own bedplate to change the tilt angle through a power-driven device, the well-known tilt table, however, only provides the manual functions of tilt angle adjustment, rising/lowering rate control, and time control. Moreover, the tilt angle of the bedplate of the tilt table is controlled and adjusted in reference to the dizzying feeling told by a tester in a testing process and the experience judgment of an operator. Therefore, when one of the above-mentioned statuses is abnormal or cannot match each other, such as the tester can not explicitly express his dizzying feeling, or the operator adjusts the tilt angle according to his subjective experience, etc., it is easy to make the tester dizzy and bad psychological stress.

The above-mentioned tilt angle control uses open-loop design architecture, and the operation parameters, such as tilt angle, and adjustment speed, etc., and the operation method in a general testing process are regularized, such as the tilt angle is gradually increased after a tester lies horizontally and is not stopped and lowered until the tester is dizzy or even in a state of shock. Hence, when the tilt angle and the adjustment speed are unsuitable, it is easy to make the tester dizzy or even in a state of shock and make the tester second hurt since the tester could be a rehabilitation patient. Further, the experience of dizzying and in a state of shock to the tester can make them heavy psychological stress and negative result in his long term treatment.

According to the research and documents, the physiological statuses of a tester in a tilt table testing process and his dizzy feeling have a close relationship. Presently, the clinical signals, such as the signals for blood pressure, pulse, electrocardiogram, and brain blood, etc., are commonly used as physiological indexes for evaluating the state of dizzying, such as postural hypotension. Therefore, in order to solve the problem resulted from the well-known tilt table that uses open-loop architecture to control the tilt angle, to eliminate the status that an operator adjusts the tilt angle according to his subjective experience, and to help the tester to explicitly express his dizzy feeling during his testing process, a tilt table including a device and functions for feeding back physiological signals and automatically adjusting the tilt angle not only can improve the safety of the testing process but also can provide objective evaluation tools for the testing results and the progress indexes.

In view of the drawbacks mentioned with the tilt table in the prior art, there is a continued need to develop a new and improved tilt table that overcomes the disadvantages associated with the tilt table in the prior art. The advantages of this invention are that it solves the problems mentioned above.

### SUMMARY OF THE INVENTION

In accordance with the present invention, a system and method for controlling a tilt table substantially obviates one or more of the problems resulted from the limitations and disadvantages of the prior art mentioned in the background.

The present invention provides a physiological sensing module to measure and to feed back the physiological signals of a tester in real time for being used as a basis to adjust the tilt angle of the tilt table, and to control the measuring time and frequency according to the physiological status of the tester, so as to achieve a safe treatment.

The present invention provides a tilt table control module to process measured physiological signals and to perform an adjustment process for the tilt table, so as to adjust the tilt table to a tilt angle.

The present invention integrates the physiological sensing, the tilt table control, and the related input/output modules to provide a multi-functional system for controlling the tilt table.

The present invention provides a method for controlling a tilt table to control the tilt angle of the bedplate of the tilt table through feeding back the physiological signals of the tester.

In accordance with the present invention, a system for controlling a tilt table is disclosed. The system includes a physiological sensing module sensing the physiological status of a person lying on the tilt table and generating at least one physiological signal, and a tilt table control module receiving the at least one physiological signal and at least one corresponding changed threshold to compare the physiological status of the person and generating an angle adjustment value. Whereby, the tilt table control module can perform an adjustment process to adjust the tilt table to a tilt angle according to the angle adjustment value.

The present invention further discloses a method for controlling a tilt table. The method includes measuring the physiological status of a person lying on the tilt table and generating at least one physiological signal, receiving the at least one physiological signal and at least one corresponding changed threshold to compare the status of the person and generating an angle adjustment value, and performing an adjustment process, wherein the adjustment process adjusts the tilt table to a tilt angle according to the angle adjustment value.

### BRIEF DESCRIPTION OF THE DRAWINGS

The foregoing aspects and many of the attendant advantages of this invention will become more readily appreciated as the same becomes better understood by reference to the following detailed description, when taken in conjunction with the accompanying drawings, wherein:

FIG. 1A illustrates a schematic system block diagram for a preferred embodiment in accordance with the present invention;

FIG. 1B illustrates one preferred embodiment block diagram of FIG. 1;

FIG. 2A illustrates a preferred embodiment flow chart in accordance with the present invention;

FIG. 2B illustrates a flow chart for a preferred adjustment process embodiment in accordance with the present invention; and

FIG. 2C illustrates a flow chart for a preferred physiological signal feedback control embodiment in accordance with the present invention.

### DESCRIPTION OF THE PREFERRED EMBODIMENT

Some embodiments of the invention will now be described in greater detail. However, it should be noted that the present invention can be practiced in a wide range of other embodiments besides those explicitly described, and the scope of the present invention is expressly not limited except as specified in the accompanying claims. Moreover, some irrelevant details are not drawn in order to make the illustrations concise and to provide a clear description for easily understanding the present invention.

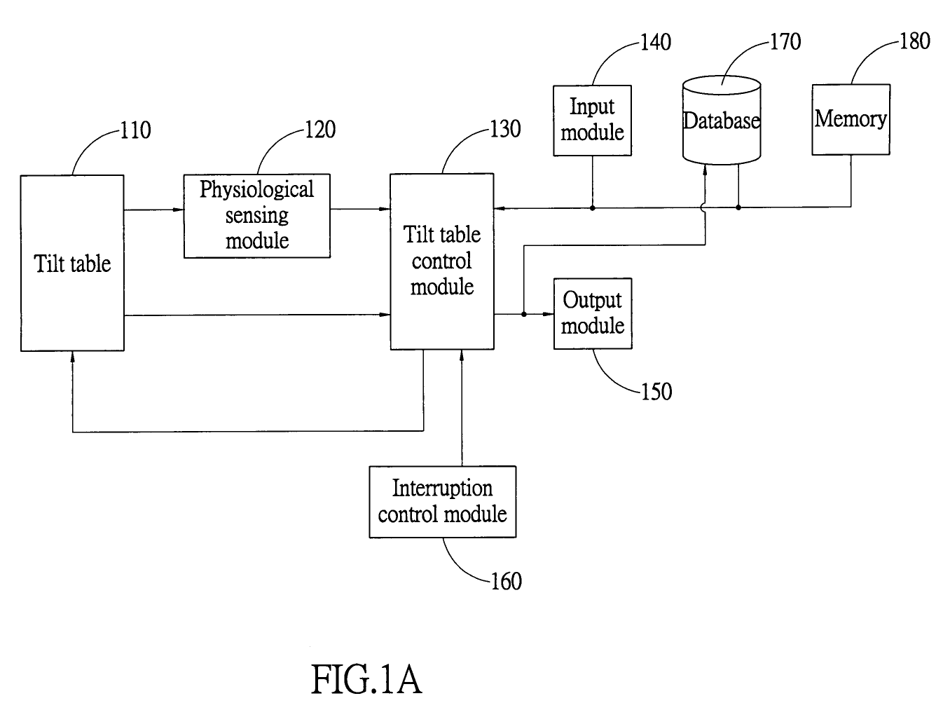

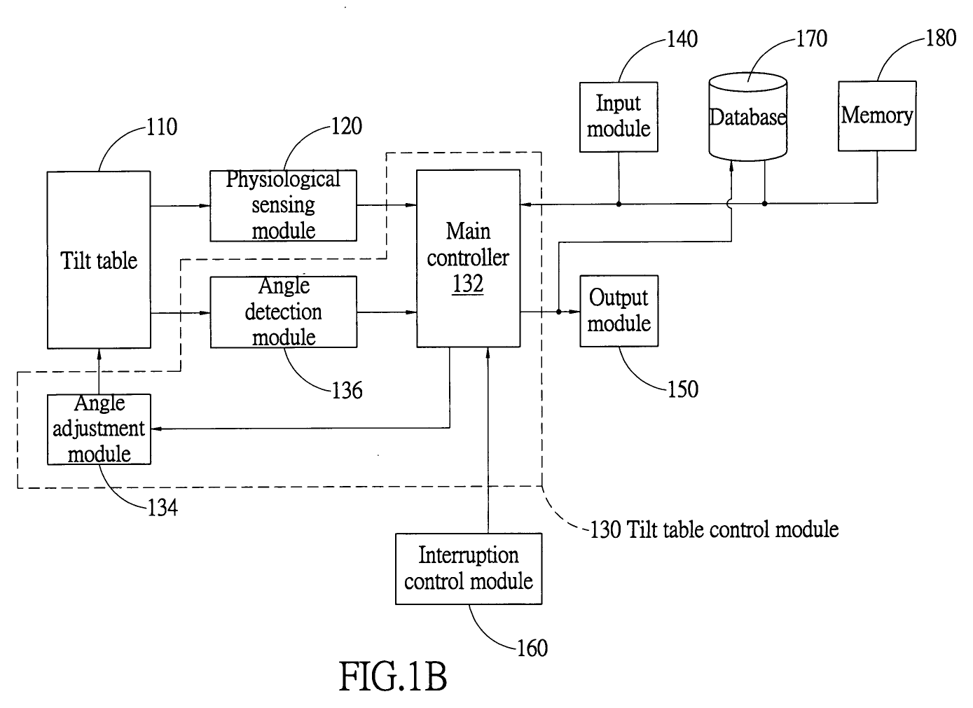

Referring to FIG. 1, a schematic system block diagram for a preferred embodiment in accordance with the present invention is illustrated. A physiological sensing module 120 measures the physiological status of a tester lying on a tilt table 110 and generates at least one physiological signal. The physiological sensing module 120 at least includes one of the following and any combinations thereof: a sensor for blood pressure, a sensor for pulse, a sensor for cardiograph, a sensor for brain waves, a sensor for brain blood, a sensor for oximeter, a sensor for heart rate, and a sensor for spirometer. A tilt table control module 130 receives the above-mentioned at least one physiological signal and at least one corresponding changed threshold to compare the physiological status of the tester and generates an angle adjustment value, so that the tilt table control module 130 can executes an adjustment process to adjust the bedplate of the tilt table 110 to a tilt angle according to the angle adjustment value. Generally speaking, the corresponding changed threshold corresponds to the physiological signal. For example, when the physiological signal is the signal of blood pressure, the corresponding changed threshold could be a changed value in 20 mmHg of systolic pressure, but should not be limited to. Moreover, when the change of the physiological signal is over the corresponding changed threshold, the tilt table control module 130 generates an angle adjustment value to adjust the tilt angle of the bedplate of the tilt table 110.

At the present day, many scholars want to research the relationship between the brain status and the faint by using ultrasonic system. When the faint happens because of the postural hypotension, the relationship between the brain status and the faint could be derived from the carotid arterial blood flow variation. For example, the faint would happen when the brain blood flow decreases about 50%, wherein the brain blood flow is derived from the carotid arterial blood flow.

As the above-mentioned, the physiological sensing module could be a sensor for brain blood monitoring the carotid artery by using ultrasonic system so as to derive at least one brain blood signal which could be at least one brain blood flow signal. Then, the tilt table control module receives and compares at least one brain blood flow signal with at least one brain blood flow corresponding changed threshold to derive the physiological status of a person and generates the angle adjustment value, whereby the tilt table control module performs an adjustment process to adjust the tilt table to a tilt angle according to the angle adjustment value. Therefore, the system for controlling a tilt table could remedy the faint because the tilt table control module adjusts the tilt table about the brain of the person.

In addition, the sensor for oximeter is configured with an ear for measuring the blood oxygen concentration and plethysmograph (especially the potoplethysmography) by a pulse oximetry, wherein the pulse oximetry generates the light for transmitting through a capillary bed, and as arterial pulsations fill the capillary bed, the changes in volume of the vessels modify the absorption, reflection, and scattering of the light, whereby the plethysmograph could display the parameters of the blood vessel derived from the absorption, reflection, and scattering of the light. Then, the tilt table control module receives and compares the blood oxygen concentration with the blood oxygen concentration corresponding changed threshold to derive the physiological status of the person and generates the angle adjustment value, whereby the tilt table control module performs an adjustment process to adjust the tilt table to a tilt angle according to the angle adjustment value.

Furthermore, the physiological status can be deduced from measuring the heart rate and the blood pressure influenced by the autonomic nervous system which can adjust and control the RRI (RR interval), wherein an array of the arrhythmic RRI is called “heart rate variability”. Moreover, the RRI could be obtained by using the detecting method for QRS wave, and then the heart rate is acquired by computing the RRI with the Boxar interpolation. Finally, we could obtain the heart rate variability transformed from the heart rate by fast fourier transform (TFT). By combining the foregoing method with the system for controlling a tilt table, we could more clearly understand the relation between the heart rate variability and the angle change of the tilt table to analyze the injured degree of the autonomic nervous system of a patient, especially the SCI (Spinal Cord Injury) patient.

In the present embodiment, the physiological sensing module 120 should not be limited to generate only one physiological signal, but can simultaneously measure and generate various physiological signals according to the physiological status of the tester. As for the above-mentioned corresponding changed threshold, it could be set and inputted from an input module 140, such as keyboard, mouse, digitizer, and touch panel, etc., to the tilt table control module 130, could be retrieved from a database 170 that records the corresponding changed thresholds for the testers, or could be transmitted form a memory 180, such as nonvolatile memory, that sets and stores the corresponding changed thresholds in advance.

An output module 150, such as displayer, printer, and speaker, etc., is utilized to receive the output data of the tilt table control module 130 and to display the messages including the safe ranges for the corresponding changed threshold, the quantified values for the physiological status of the tester in a testing process, the tilt angles of the bedplate of the tilt table, and so forth. Moreover, when the change of the physiological signal is over the corresponding changed threshold, the output module 150 can further generate a warning action via the control of the tilt table control module 130, such as displaying a warning message on the displayer, buzzing the speaker, and so forth. Besides, the database 170 can also receive the output data of the tilt table control module 130 and stores it in electronic format, such as the safe ranges for the corresponding changed threshold, the quantified values for the physiological status of the tester in a testing process, the tilt angles of the bedplate of the tilt table, and so forth. Whereby, the testing records and history of a tester can be completely stored to provide the related people to study, such as providing to the medical stuffs to use as the reference for further treatment. An interruption module 160 is employed to stop that the tilt table control module 130 adjusts the tilt angle of the bedplate of the tilt table 110. The interruption module 160 further provides a manual adjustment function for people to adjust the tilt angle of the bedplate of the tilt table 110.

Referring to FIG. 1B, one preferred embodiment block diagram of FIG. 1 is illustrated. The difference between FIG. 1B and FIG. 1A is that FIG. 1B further illustrates one preferred embodiment for the tilt table control module 130 shown in FIG. 1A. Wherein, the tilt table control module 130 includes a main controller 132, an angle adjustment module 134, and an angle detection module 136. The angle detection module 136 detects the angle of the bedplate of the tilt table 110 and generates a detected angle value. The main controller 132 not only receives the above-mentioned at least one physiological signal and at least one corresponding changed threshold to compare the physiological status of the tester to generate the above-mentioned angle adjustment value, but also receives and compares the detected angle value detected and generated by the angle detection module 136 with the angle adjustment value to generate a tilt angle value. For example, when the detected angle value shows 45, that means the angle of the bedplate of the tilt table 110 is 45 degrees but should not be limited to, and the angle adjustment value shows −15, the tilt angle value should be 30 after the calculation, that means the angle of the bedplate of the tilt table 110 should be lowered from 45 to 30 degrees. The angle adjustment module 134 receives control signals generated by the main controller 132 according to the angle adjustment value to adjust the angle of the bedplate of the tilt table 1 10.

During executing the process for adjusting the tilt angle of the bedplate of the tilt table 110, the angle adjustment module 136 keeps detecting the tilt angle of the bedplate of the tilt table 110 to provide to the main controller 132 to compare to the tilt angle corresponding to the above-mentioned tilt angle value. When both of them are equal to each other, that means, the angle of the bedplate of the tilt table 110 has been adjusted to the tilt angle corresponding to the tilt angle value, the process is therefore finished. This process is so-called adjustment process mentioned above. Besides, the adjustment process could also be performed through the main controller 132 directly transforming the above-mentioned angle adjustment value into the control signals of the angle adjustment module 134. For example, when one control signal generated by the main controller 132 can make the angle adjustment module 134 change the tilt angle of the bedplate of the tilt table 100 in 0.5 degree, but should not be limited to, and when the angle adjustment value is 15, the main controller 132 only needs to transform the angle adjustment value into 30 control signals of the angle adjustment module to adjust the angle of the bedplate of the tilt table 100, and the adjustment process is then finished. In the present embodiment, the main controller 132 could be a personal computer, or a micro control system with a single chip, and the angle adjustment module 134 could be a stepping motor.

As for the interruption module 160, it can generate an interruption signal to the main controller 132. The main controller 132 stops transmitting control signals to the angle adjustment module 134 as soon as receiving the interruption signal. Whereby, the interruption module 160 can stop the adjustment process being proceeding. Also, the interruption module 160 can further protect the angle adjustment module 134 through the main controller 132 interrupting the control signal, and provides a manual adjustment function for people to adjust the tilt angle of the bedplate of the tilt table 110.

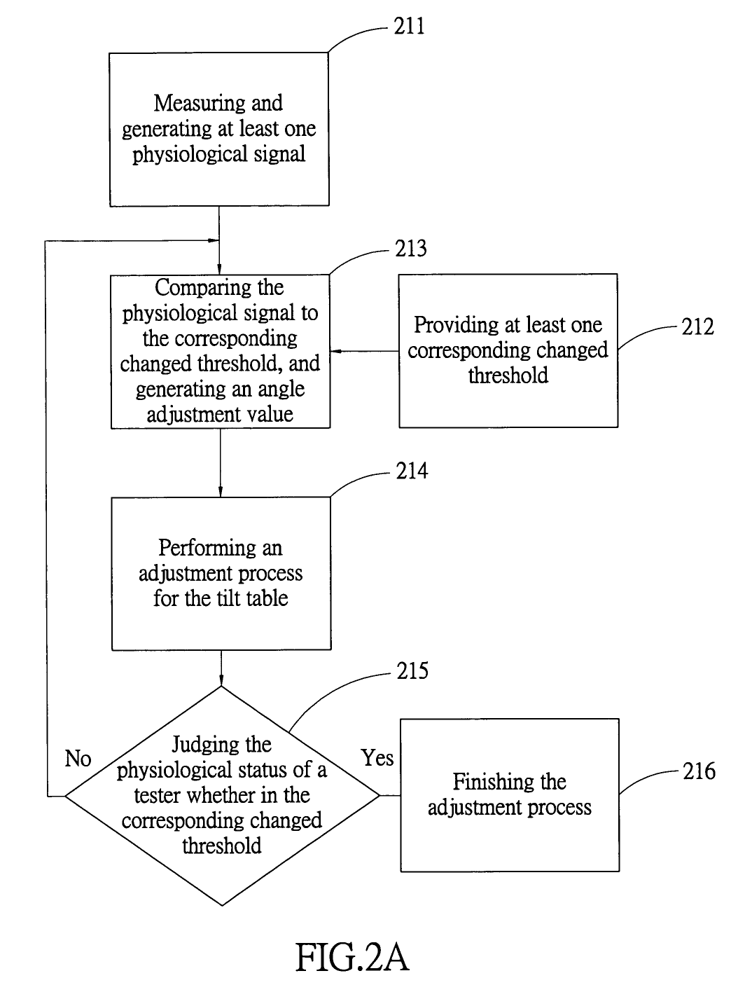

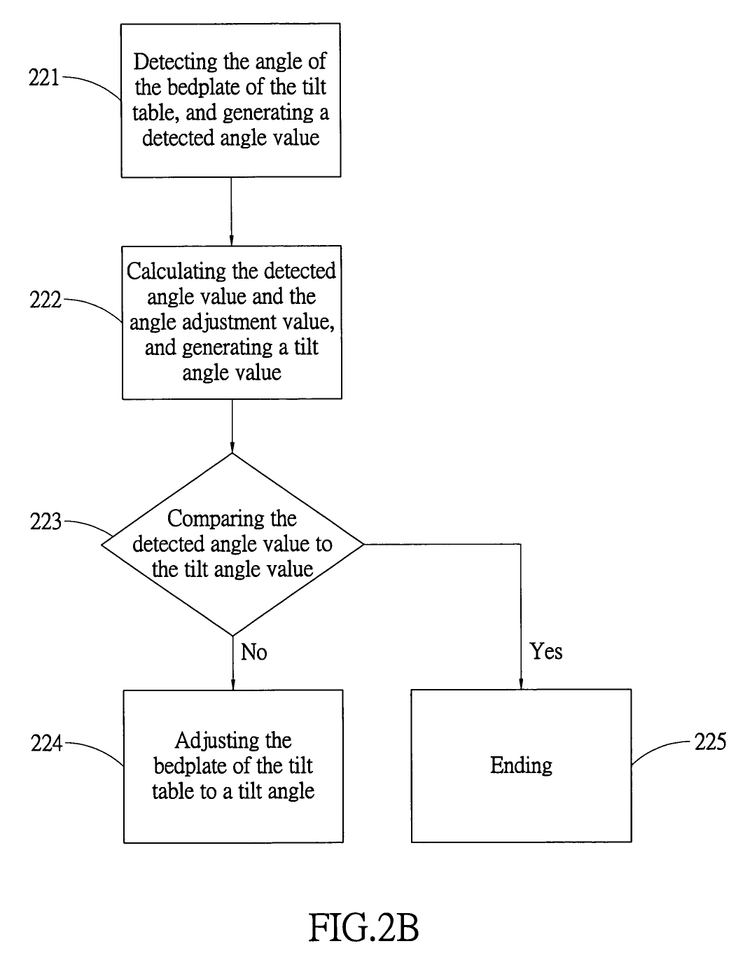

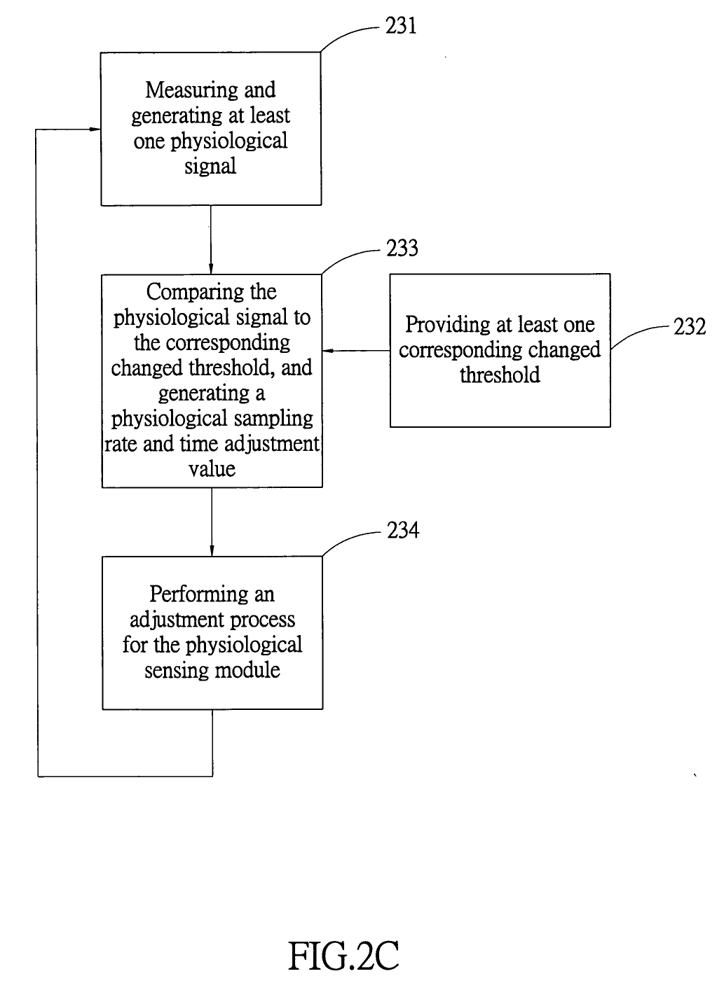

Referring to FIG. 2A, a preferred embodiment flow chart in accordance with the present invention is illustrated. In step 211, a physiological sensing module measures the physiological status of a tester lying on a tilt table and generates at least one physiological signal, wherein the physiological signal could be a signal for blood pressure, a signal for pulse rate, a signal for electrocardiogram, a signal for brain waves, a signal for brain blood, a signal for oximeter, a signal for spirometer, and so forth. In step 213, a tilt table control module receives the above-mentioned at least one physiological signal and at least one corresponding changed threshold (as shown in step 212) to compare the physiological status of the tester, that is, to compare the physiological signal to the corresponding changed threshold, and generates an angle adjustment value. Wherein, the at least one corresponding changed threshold could be transmitted form an input module, a memory, or a database to the tilt table control module. In step 214, the tilt table executes an adjustment process to adjust the bedplate of the tilt table to a tilt angle according to the angle adjustment value. In step 215, the tilt table control module judges the physiological status of the tester if in the corresponding changed threshold, that is, the physiological signal whether smaller than the corresponding changed threshold. When the answer is negative, the steps 213, 214, and 215 keep performing; in contrast, when the answer is positive, the adjustment process is finished, as shown in step 216.

Referring to FIG. 2B, a flow chart for a preferred adjustment process embodiment in accordance with the present invention is illustrated. In step 221, an angle adjustment module detects the angle of the bedplate of the tilt table and generates a detected angle value. In step 222, a main controller calculates the detected angle value and the above-mentioned angle adjustment value and generates a tilt angle value. In step 223, the main controller compares the detected angle value to the tilt angle value. When the detected angle value is not equal to the tilt angle value, the angle adjustment module adjusts the bedplate of the tilt table to the tilt angle, as shown in step 224, and the steps 223 and 224 keep performing; in contrast, when the detected angle value is equal to the tilt angle value, the angle adjustment module stops the adjust process, as shown in step 225.

Referring to FIG. 2C, a flow chart for a preferred physiological signal feedback control embodiment in accordance with the present invention is illustrated. In step 231, a physiological sensing module measures the physiological status of a tester lying on a tilt table and generates at least one physiological signal. In step 233, a tilt table control module receives the above-mentioned at least one physiological signal and at least one corresponding changed threshold (as shown in step 232) to compare the physiological status of the tester, that is, to compare the physiological signal of the tester to the corresponding changed threshold, and generates a physiological sampling rate and time adjustment value. Wherein the physiological sampling rate and time adjustment value is utilized to control the measuring time and frequency of the physiological sensing module. In step 234, the physiological sensing module adjusts its measuring time and frequency according to the physiological sampling rate and time adjustment value. Then, the steps 231, 233, and 234 keep performing in the feedback control.

From another aspect, the present invention provides closed loop control architecture to improve the well-known tilt table that employs open-loop control architecture. Referring to FIG. 1B and FIG. 2A again, a closed loop for physiological signal feedback control in accordance with the present invention includes the following: the physiological sensing module 120 performing the step 211; the main controller 132 performing the step 213; and the main controller 132, the angle adjustment module 134, and the tilt table 110 performing the step 214. Wherein, the above-mention modules and steps that have been described above are respectively included in closed loop control architecture and a closed loop control method. By doing so, employing the physiological signal measured form the tester controls the tilt angle of the bedplate of the tilt table.

Referring to FIG. 1B and FIG. 2B again, a closed loop for tilt angle control in accordance with the present invention includes the following: the angle detection module 136 performing the step 221; the main controller 132 performing the steps 222 and 223; and the main controller 132, the angle adjustment module 134, and the tilt table 110 performing the step 224. Wherein, the above-mention modules and steps that have been described above are also respectively included in closed loop control architecture and a closed loop control method. By doing so, the tilt table is able to automatically perform the adjustment process to adjust the tilt angle of the bedplate thereof.

Referring to FIG. 1B and FIG. 2C again, a closed loop for physiological signal sampling control in accordance with the present invention includes the following: the physiological sensing module 120 performing the step 231; and the main controller 132 performing the step 233 and controlling the physiological sensing module 120 to perform the step 234 according to the result of the step 233. For example, when the change of the physiological signal measured by the physiological sensing module 120 through the main controller 132 comparing to the corresponding changed threshold goes beyond, the main controller 132 increases the measuring time or frequency of the physiological sensing module 120, such as measuring the tester form every five minutes to every three minutes, but should not be limited to. By doing so, automatically adjusting the sampling rate (or measuring frequency) of the physiological sensing module 120 provides a more accurate measuring record and control.

Although specific embodiments have been illustrated and described, it will be obvious to those skilled in the art that various modifications may be made without departing from what is intended to be limited solely by the appended claims.

What is claimed is:

1. A system for controlling a tilt table, said system comprising:
a physiological sensing module, measuring the physiological status of a person lying on the tilt table and generating at least one physiological signal, wherein said physiological sensing module comprises a sensor for brain blood, and said at least one physiological signal comprises at least one brain blood flow signal, wherein said sensor for brain blood derives said at least one brain blood flow signal by using ultrasonic system to measure at least one carotid arterial blood variation; and
a tilt table control module, receiving said at least one physiological signal and at least one corresponding changed threshold to compare the physiological status of the person and generating an angle adjustment value;
whereby said tilt table control module being able to perform an adjustment process to adjust the tilt table to a tilt angle according to said angle adjustment value, wherein said at least one corresponding changed threshold comprises at least one brain blood flow corresponding changed threshold, wherein said tilt table control module receives and compares said at least one brain blood flow signal with said at least one brain blood flow corresponding changed threshold so as to derive the physiological status of the person and generates said angle adjustment value for remedying the faint.

2. The system according to claim 1, wherein said physiological sensing module at least includes one of the following and any combinations thereof: a sensor for blood pressure, a sensor for pulse, a sensor for cardiograph, a sensor for brain waves, a sensor for oximeter, a sensor for heart rate, and a sensor for spirometer, wherein said sensor for oximeter measures the blood oxygen concentration and plethysmograph by a pulse oximetry.

3. The system according to claim 1, wherein said tilt table control module comprise:
an angle detection module, detecting the tilt angle of the bedplate of the tilt table and generating a detected angle value;
a main controller, receiving said at least one physiological signal and said at least one corresponding changed threshold to compare the physiological status of the person and generating said angle adjustment value, wherein said main controller also receives and compares said detected angle value with said angle adjustment value so as to generate a tilt angle value; and
an angle adjustment module, receiving said angle adjustment value and adjusting the tilt table to a tilt angle according to said angle adjustment value.

4. The system according to claim 3, wherein said main controller compares said detected angle value to said tilt angle value, and said angle adjustment module adjusts the tilt angle of the bedplate of the tilt table according to said angle adjustment value when said detected angle value is not equal to said tilt angle value.

5. The system according to claim 3, wherein said main controller compares said detected angle value to said tilt angle value, and said angle adjustment module does not work when said detected angle value is equal to said tilt angle value.

6. The system according to claim 1, further comprising an interruption control module, wherein said interruption control module is able to interrupt said adjustment process performed by said tilt table control module.

7. The system according to claim 6, wherein said interruption control module further provides a manual adjustment function for people to adjust the tilt angle of the bedplate of the tilt table.

8. The system according to claim 1, wherein said at least one corresponding changed threshold is sent to said tilt table control module from one of the following: an input module, a memory, and a database.

9. The system according to claim 1, further comprising an output module, wherein said output module at least includes one of the following and any combinations thereof: a displayer, a printer, a speaker, and a database.

10. A system for controlling a tilt table, said system comprising:
a physiological sensing module, measuring the physiological status of a person lying on the tilt table and generating at least one physiological signal, wherein said physiological sensing module comprises a sensor for brain blood, and said at least one physiological signal comprises at least one brain blood flow signal, wherein said sensor for brain blood derives said at least one brain blood flow signal by using ultrasonic system to measure at least one carotid arterial blood variation;
an angle detection module, detecting the tilt angle of the bedplate of the tilt table and generating a detected angle value;
a main controller, receiving said at least one physiological signal and at least one corresponding changed threshold to compare the physiological status of the person and generating an angle adjustment value, wherein said main controller also receives said detected angle value to calculate said detected angle value and said angle adjustment value and generates a tilt angle value; and
an angle adjustment module, receiving said angle adjustment value and adjusting the tilt table to a tilt angle according to said angle adjustment value, wherein said at least one corresponding changed threshold comprises at least one brain blood flow corresponding changed threshold, wherein said tilt table control module receives and compares said at least one brain blood flow signal with said at least one brain blood flow corresponding changed threshold so as to derive the physiological status of the person and generates said angle adjustment value for remedying the faint.

11. The system according to claim 10, wherein said main controller compares said detected angle value to said tilt angle value, and said angle adjustment module adjusts the tilt angle of the bedplate of the tilt table according to said angle adjustment value when said detected angle value is not equal to said tilt angle value.

12. The system according to claim 10, wherein said main controller compares said detected angle value and said tilt angle value, and said angle adjustment module does not work when said detected angle value is equal to said tilt angle value.

13. The system according to claim 10, wherein said physiological sensing module at least includes one of the following and any combinations thereof: a sensor for blood pressure, a sensor for pulse, a sensor for cardiograph, a sensor for brain waves, a sensor for oximeter, a sensor for heart rate, and a sensor for spirometer, wherein said sensor for oximeter measures the blood oxygen concentration and plethysmograph by a pulse oximetry.

14. The system according to claim 10, further comprising an interruption control module, wherein said interruption control module is able to interrupt the control performed by said main controller to said angle adjustment module, and said interruption control module further provides a manual adjustment function for people to adjust the tilt angle of the bedplate of the tilt table.

15. The system according to claim 10, wherein said at least one corresponding changed threshold is sent to said main controller from one of the following: an input module, a memory, and a database.

16. The system according to claim 10, further comprising an output module, wherein said output module at least includes one of the following and any combinations thereof: a displayer, a printer, a speaker, and a database.

17. A method for controlling a tilt table, said method comprising:
measuring the physiological status of a person lying on the tilt table and generating at least one physiological signal, wherein said at least one physiological signal comprises at least one brain blood flow signal;
receiving said at least one physiological signal and at least one corresponding changed threshold to compare the status of the person and generating an angle adjustment value, wherein said at least one corresponding changed threshold comprises at least one brain blood flow corresponding changed threshold; and
performing an adjustment process, wherein said adjustment process adjusts the tilt table to a tilt angle according to said angle adjustment value.

18. The method according to claim 17, wherein said adjustment process further includes:
detecting the tilt angle of the bedplate of the tilt table and generating a detected angle value;
calculating said detected angle value and said angle adjustment value and generating a tilt angle value; and
adjusting the tilt table to said tilt angle when said detected angle value is not equal to said tilt angle value.

19. The method according to claim 18, when said detected angle value is equal to said tilt angle value, stopping said adjustment process.

20. The method according to claim 17, wherein said physiological signal at least includes one of the following and any combinations thereof: a signal for blood pressure, a signal for pulse rate, a signal for electrocardiogram, a signal for brain waves, a signal for oximeter, and a signal for spirometer.

21. A method for controlling a tilt table, said method comprising:
performing a physiological signal feedback control, said physiological signal feedback control comprising:
measuring the physiological status of a person lying on the tilt table and generating at least one physiological signal, wherein said at least one physiological signal comprises at least one brain blood flow signal;
receiving said at least one physiological signal and at least one corresponding changed threshold to compare the status of the person and generating an angle adjustment value, wherein said at least one corresponding changed threshold comprises at least one brain blood flow corresponding changed threshold; and
adjusting the tilt table to a tilt angle according to said angle adjustment value;
and
performing a tilt angle control, said tilt angle control comprising:
detecting the tilt angle of the bedplate of the tilt table and generating a detected angle value;
calculating said detected angle value and said angle adjustment value and generating a tilt angle value; and
adjusting the tilt table to said tilt angle when said detected angle value is not equal to said tilt angle value.

22. The method according to claim 21, further comprising:
performing a physiological signal sampling control, said physiological signal sampling control comprising:
receiving said at least one physiological signal and said at least one corresponding changed threshold to compare the status of the person and generating a physiological sampling rate and time adjustment value; and
adjusting the time and frequency for measuring the physiological status of the person according to said physiological sampling rate and time adjustment value.
